(19) United States
(12) Patent Application Publication
(10) Pub. No.: US 2019/0258943 A1
(43) Pub. Date: Aug. 22, 2019

(54) RULE-BASED SYSTEM AND METHOD TO BE USED IN THE SYSTEM

(71) Applicant: Profium Oy, Espoo (FI)

(72) Inventors: Tommi Koivula, Sundsberg (FI); Jari Vänttinen, Mikkeli (FI)

(21) Appl. No.: 15/932,289

(22) Filed: Feb. 16, 2018

(51) Int. Cl. G06N 5/02; G06N 5/04; G06F 17/30

(52) U.S. Cl. CPC G06N 5/025; G06F 17/30554; G06N 5/046

(57) ABSTRACT

A computer-implemented reasoning method for analyzing inference by using a data model with facts and rules, wherein the data model is used for analyzing rule triggering by means of an algorithm. The method includes providing the data model as a data structure with a first presentation and a second presentation. The first presentation is a presentation of property values for subjects, whereby each property value states an explicit fact or a missing fact. The second presentation is a presentation of rules for the relations of the properties, the rules having been constructed in an expanded form showing separately all combinations of property relations. The algorithm combines the presentations of the data structure by matching the rules against the properties of the subjects. A search result is obtained, which exposes the relations between the rule results and the property values of the subjects.

### FIELD

The invention is concerned with a rule-based system and a reasoning method for analyzing inference.

### BACKGROUND INFORMATION

Semantics is the linguistic and philosophical study of meaning, in language, programming languages, formal logics, and semiotics. It is concerned with the relationship between signifiers—like words, phrases, signs, and symbols—and what they stand for, their denotation.

In e.g. Semantic Web, rules about the data are often expressed as ontologies that describe the characteristics of the data for expressing knowledge by means of a shared vocabulary instead of just presenting document contents as such, like in e.g. Current World Wide Web (WWW).

Ontology forms a base for structured knowledge in computer science and information science being a formal naming and definition of the types, properties, and interrelationships of the entities that really exist in a particular domain of discourse. The domain of discourse, is the set of entities over which certain variables of interest in some formal treatment may range.

Thus, the backbone of ontology is basically a taxonomy, i.e. a classification of things in a hierarchical form. Pragmatically, an ontology defines the vocabulary with which queries and assertions are exchanged. The ontological commitment is then a guarantee of consistency for communications.

An ontology in information science establishes the relationships between the variables needed for computations. The fields of e.g. artificial intelligence, the Semantic Web, and information architecture all create ontologies to limit complexity and organize information. The ontology can then be applied to problem solving.

Reasoning means deriving facts that are not expressed in ontology or in knowledge base explicitly. Information about the data, called as metadata, is something that benefits especially from reasoning. Inferred metadata often reduces human interaction required when combining or utilizing different data sources at the same time.

Reasoning systems play an important role in the implementation of artificial intelligence and knowledge-based systems. Reasoning systems have a wide field of application that includes scheduling, business rule processing, problem solving, intrusion detection, predictive analytics, robotics, computer vision, and natural language processing.

In information technology, a reasoning system is a software system that generates conclusions from available knowledge using steps of logical techniques. Inferences are steps in reasoning, moving from premises to conclusions according to rules. Thus, reasoning methods follow specific “rules of inference” based on what “logical connectives” they use, such as “and” or “or”.

The mechanism of inference applies rules to existing facts to reach new conclusions. A rule (or a production) is a logical statement that relates two or more properties and includes two parts: the premise and the conclusion in the form “if premise then conclusion”. The premise can also be called “the body” or “the antecedent” and the conclusion can also be called “the head” or “the consequent”, especially when talking about the principal parts of an association rule. The two parts of a rule can also be called: a precondition (or “IF” statement) and an action (or “THEN”).

If a rule's precondition matches the current state of an embodiment, then the rule is said to be triggered. If a production's action is executed, it is said to have fired. Furthermore, the conclusion of a rule can be referred to as “the rule result”.

An inference rule is a tuple (P1, Pn, C), where, P1, Pn, C are formulas, wherein Pi are called premises and C is called a conclusion. A tuple is a finite ordered list (sequence) of elements usually written within parentheses. Intuitively, the rules say that the conclusion is true if the premises are.

A search algorithm retrieves information stored within some data structure, or calculated in a search space of a problem domain. Examples of such structures include a Linked List, an Array data structure, or a Search tree. The appropriate search algorithm often depends on the data structure being searched, and may also include prior knowledge about the data. Searching also encompasses algorithms that query the data structure. Linear search algorithms check every record for the one associated with a target key in a linear fashion. Searches outside a linear search require that the data be sorted in some way. Algorithms for searching virtual spaces are used in the constraint satisfaction problem, where the goal is to find a set of value assignments to certain variables that will satisfy specific mathematical equations and inequations/equalities.

An inference rule used in logic programming can define a search tree of alternative computations, in which the initial goal clause is associated with the root of the tree. A search tree is a tree data structure consisting of nodes used for locating specific keys from a set. Traversing a tree involves iterating over all nodes in some manner.

Thus, a reasoning with rules means that requirements of a rule-based system shall be filled. In matching (or unification), terms are matched (or unified) against the components of rules (premises and conclusions). Rules express various different kinds of relations. Thus, each rule (also called ‘production’) binds a conjunction of predicate clauses to a list of executable actions.

At run-time, the rules are matched against facts and the associated action list are executed (fired) for each match. If those actions remove or modify any facts, or assert new facts, then the set of matches are recomputed.

An inference system's job is to extend a knowledge base automatically. The Knowledge Base (KB) is a set of propositions that represent what the system knows. Propositions (such as premises and conclusions) are the primary bearers of truth-value. A truth-bearer is an entity that is said to be either true or false.

A knowledge base (KB) is a technology used to store complex structured and unstructured information used by a computer system. Several techniques can be used to extend the KB by means of valid inferences.

In the field of Artificial Intelligence, inference engine is a component of a system that applies logical rules to the knowledge base to deduce new information, i.e. derives inferred facts from explicit facts. The inference engine is traditionally a component of an expert system. An expert system is a computer system that emulates the decision-making ability of a human expert. Expert systems are designed to solve complex problems by reasoning through bodies of knowledge, represented mainly as if-then rules. The typical expert system consists of a knowledge base and an inference engine.

The knowledge base stores facts and rules. The inference engine applies the rules to the known facts to deduce new facts. The logic that an inference engine uses is typically represented as IF-THEN rules. This process would iterate as each new fact in the knowledge base can trigger additional rules in the inference engine. Other common components of an expert system include a user interface and an explanatory interface.

This approach is widely used e.g. to model and apply business rules to control decision making. A software system can e.g. execute one or more business rule in a runtime production environment. The rules might come from legal regulation, company policy, or other sources and. Rule engines typically support rules, facts, priority (score), mutual exclusion, preconditions, and other functions.

A problem with rule based inference is that a rule will trigger only if all of the conditions of the rule are met, whereas there is a need to determine what kind of data would make a certain rule to fire in a knowledge base with a large number of complex rules interacting with each other. Neither do traditional methods give any hint of which rules that are closest to match.

In contrary to rule based inference that does not provide any explanations of why a rule was trigger or any recommendations for how to make a rule to trigger, there are error prone and impractical in real use case scenarios, which are compared to predictive approaches where rule evaluation is transparent with explanations and recommendations.

Known methods for predicting rule evaluation results exist. Predicting is making claims about something that will happen, often based on information from past and from current state. Basic criteria are data that we have for teaching prediction and for prediction what we want to predict—like value or trend. Also, statistical analysis and pattern recognition algorithms have been used for predicting results.

Reasoning properties are typically expressed using Datalog language with Horn clauses. Data tuples and horn clause rules as such are also used in known expert systems. Datalog is a declarative logic programming language that syntactically is a subset of Prolog. It is often used as a query language for deductive databases. A deductive database is a database system that can make deductions (i.e., conclude additional facts) based on rules and facts stored in the (deductive) database. Prolog is primarily expressed in terms of relations, represented as facts and rules. A computation is initiated by running a query over these relations. Prolog has been used for theorem proving, expert systems, term rewriting, type inference, and automated planning, as well as its original intended field of use, natural language processing.

In expert systems, when modeling and monitoring complex systems operation, Fault Tree Analysis (FTA) has been used to estimate faults before they occur. A fault tree is a tree wherein nodes are faults, which are connected with logical relations to each other. A root fault occurs with a certain probability that can be calculated from the probabilities of the children faults. The use of fault trees leads to a computational complexity that can lead to performance and scalability issues with a large number of tuples and complex rule sets.

### OBJECT AND SUMMARY

An object of this invention is to develop a more efficient reasoning method.

A first aspect of the invention is directed to a computer-implemented reasoning method for analyzing inference by using a data model with facts and rules. The data model is used for analyzing rule triggering by means of an algorithm. The method comprises providing the data model as a data structure with a first presentation and a second presentation. The first presentation is a presentation of property values for subjects, whereby each property value states an explicit fact or a missing fact. The second presentation is a presentation of rules for the relations of the properties, the rules having been constructed in an expanded form showing separately all combinations of property relations. The algorithm combines the presentations of the data structure by matching the rules against the properties of the subjects. A search result is obtained, which exposes the relations between the rule results and the property values of the subjects. The search result is interpreted on the basis of the property values.

A second aspect of the invention is directed to a system for analyzing inference presented below and the third aspect is a computer program which when executed causes performing the method of the invention.

Embodiments of the invention may have the features of the sub claims.

The explicit facts and the missing facts have been given numerical truth values enabling interpreting the search result for predicting reasoning results of inferred facts/produced properties. One or more missing explicit fact is interpreted as an additional fact or additional facts, which, when inserted in the data structure, triggers one or more rules thereof. Thus, the search result can be interpreted to predict required facts that produce(s) a given property or in other words, infer(s) (a) fact(s) for one or more subjects. A required explicit fact to make a given rule to match for a subject is indicated by a property value stating the property to be true, and a missing fact is indicated by a property value stating the property to be false.

The subjects and rules that are closest to trigger is found by means of the missing explicit facts making a given rule to trigger. Closeness is measured by the amount of missing explicit facts, and/or the weights of the missing explicit facts or their corresponding properties. Rules and/or subjects can be sorted based on how close the rules are to match.

The explicit facts and missing facts can also be given numerical truth values that enable interpreting the search result for explaining reasoning results of inferred facts/produced properties. In that case, the search result is interpreted to determine if a given property for one or more subjects is true and can thus be inferred from explicit facts and satisfy the satisfiability formula. The search result can thus be interpreted to find the explicit fact(s) that produced a given inferred property for one or more subjects. The facts that made the rule to match for a subject is indicated by the values of the required properties for that rule.

The invention uses a data model in a rule-based production system to calculate an outcome when rules are applied on explicit facts by running an algorithm on a data structure in a knowledge base. The knowledge base comprises a set of properties stating explicit facts and a set of rules that represent relations of the properties.

In the method of the invention, the data in the data structure consists of facts stating what properties hold for subjects in the data. Data is structured in an associative form in a memory in the form of a property space and is accessible by the algorithm performing the method of the invention. The property space consists of a set of structured properties with associations.

The rule-based production system of the invention is a computer program providing the mechanism necessary to achieve rule results. The system also contains a database, also called a working memory, which maintains data about current state or knowledge, and an algorithm that can work as a rule interpreter.

Properties, in this text are truth-bearers, which can be true or false.

Rules are statements that define relationships between properties.

Facts, in this text, are used to make properties true, and thus

a property that is true can be an explicit fact or an inferred fact, and

a property that is false is a missing fact.

An inventive part of the method of the invention is that it does not only deduce new information by inferring properties but instead, it can analyze reasoning both

by predicting explicit facts that make rules to trigger, and

by explaining results of reasoning by information of what explicit facts made rules to trigger.

The invention can thus be used e.g. to predict results of reasoning methods with possible facts before rules actually trigger. Instead of just using a traditional expert system with a knowledge-base and an interference engine, wherein rules are applied to the knowledge base to deduce new information, the invention uses a data model that can work as a “prediction engine”. The prediction engine outcomes a result that exposes those rules and/or facts that are required for a certain outcome of applied rules. In other word, results of inference of explicitly given data is predicted using a set of rules before the rules actually trigger.

For a given result of applied rules, it can be predicted which rules are closest to match without testing all possible facts and rules combinations to find valid set of facts that trigger said rules.

As indicated above, the invention can also be used to explain results of reasoning methods showing with facts made rules trigger. Traditional expert systems do not provide any explanations of why a rule was triggered. The invention uses a data model that can work as an “explanation engine”. The explanation engine outcomes a result that exposes those rules and/or facts that produced the outcome obtained for the applied rules.

In practice, the system of the invention usually also includes a traditional inference engine, which can be used for actually evaluating which rules trigger and to get inference results.

The data structure can be modified and updated by insertion or deletion of new subjects, rules, and/or facts, whereafter the data model is re-run. The data model is re-run by the algorithm in the modified form without the need of testing all possible fact combinations to find solutions that would trigger any of the rules that do not currently trigger. The re-run is performed each time the set of explicit facts change using the rules and facts of the modified data structure.

An advantageous embodiment of the method comprises constructing the data structure in the form of a satisfiability matrix and a search matrix for obtaining an outcome in the form of a result matrix using product operations for pre-calculated search and satisfiability matrices.

The data model is provided by constructing a satisfiability formula for the presentations of the properties in the form of a satisfiability matrix with rows for presenting the subjects and columns for presenting the properties. A search formula is constructed for the presentation of the rules in the form of a search matrix from properties and expanded forms of the rules. The expanded rules are presented by rows and the columns by the properties. A search result is obtained as a resulting data structure in the form of a result matrix by multiplying the satisfiability matrix and the search matrix.

The multiplication of the satisfiability matrix and the search matrix is then followed by concatenation.

The explicit facts and missing facts are given numerical truth values in the satisfiability matrix for enabling interpreting the search result for predicting reasoning results of inferred facts/produced properties. When the method is used for explaining reasoning results of inferred facts/produced properties, the given numerical truth values of explicit facts and missing facts are interchanged.

The state of any property for each subject is interpreted based on the existence of explicit facts indicated by the property values of the cells of the result matrix. The result matrix can thus be interpreted by means of values that indicate the required facts that make the rule that infers a property of interest to match for a subject.

The method is performed in a network of one or more nodes and can further comprise distributing at least one method step into another processing node than the executing node. Said another node is then provided with an individual working memory, shared access to a rule set and/or the right to check/evaluate the value of a property for any subject.

A method according to an embodiment of the invention thus comprises the following steps:

1) Stating properties for subjects and rules for the relations of the properties,

2) Stating explicit facts by setting

the truth value “true” on the properties of the subjects that hold for a subject, and

the truth value “false” is set on the properties that are missing and are thus false for a subject.

The numerical values for true and false (i.e. “1” or “0”) depend on whether the method is going to be used for prediction or explanation. Reference is here made to the examples in the end of the description.

4) Constructing a satisfiability formula for presenting the explicit facts.

The satisfiability formula advantageously consists of a satisfiability matrix of the property values stating the explicit facts. The satisfiability matrix has rows for presenting the subjects and columns for presenting the properties.

3) Expanding the rules by presenting the rules separately in all combinations of property relations, and presenting each rule by inserting the value “true” for the properties concerned and the value “false” for the other properties.

The numerical values for true being “1” and the numerical value for false being “0”.

4) Constructing a search formula for the presentation of the expanded rules by means of the truth values of the foregoing step.

The search formula is advantageously in the form of a search matrix. The search matrix has rows for presenting the rules and columns for presenting the properties.

5) Constitute a data structure of the satisfiability formula and search formula to be stored as a knowledge base.

5) Running a search algorithm on the data structure, which applies the rules on the explicit facts by applying a search formula on the satisfiability formula.

Advantageously, the algorithm matching the rules of the search matrix on the property values of the satisfiability matrix,

6) obtaining a search result in the form of a resulting data structure exposing the relation between the rule results and the property values of the subjects,

the resulting data structure being advantageously a result matrix of a multiplication of each of the two corresponding cells in the satisfiability matrix and the search matrix, wherein the rows exposes the results of the applied rules with truth values (“zero” or “one”)

7) interpreting the search result by either

a) predicting facts for producing a rule result for properties of interest to become true (i.e. for inferring such properties) for at least one subject in the system by means of the position of non-zero (or “1” values) in the data structure, which non-zero values represent missing facts for a given rule.

When the resulting data structure is a result matrix, the horizontal rows represent rules and the vertical columns represent facts. The rule says which of the facts should be true for the rule to trigger. Thus, the result matrix exposes missing and explicit facts for the subjects in view of each rule. Reference is made to the examples.

or b) explaining which facts produced a rule result (i.e. triggered the rule), for at least one subject in the system by means of the position of non-zero (or “1” values) in the data structure, which represent the explicit facts for a given rule.

The facts and rules interpreted from the search result to give a certain outcome can be run by an interference engine, by using the result of the method of the invention.

A system according to an embodiment of the invention is configured to execute the method of the invention. The system uses the method to a system element thereof, which comprises executing means to perform the method steps of the method of the invention.

The system of the invention for reasoning comprises a data base module with a data structure of rules, facts and/or configuration data. The data structure comprises a set of properties stating explicit facts and a set of rules that represent relations of the properties, a user interface, and a module with an algorithm applying the rules to the data structure by combining the presentations of the data structure by matching the rules against the facts of the subjects and obtaining a search result that exposes the relations between the rule results and the property values of the subject.

The computer program of the invention has instructions which when executed by a computing device or system causes the computing device or system to perform the method of the invention and run the algorithm on the current data structure.

The computer program is a software product and works as a data model configured to execute the method according to an embodiment of the invention, the algorithm applying rules of a search formula in accordance with a data model to the facts of a satisfiability formula and outcomes a search result.

More in detail, the embodiments of the invention use a system element of knowledge representation (KR) in the form of a data structure and methods for managing results of inference of explicitly given data using a set of rules. Predicting results of inference can be performed before the rules actually trigger and inference results can be interpreted to explain the fact that produced inferred properties.

The system according to an embodiment of the invention is run by a processor and comprises components such as a data model, and a knowledge base. The data model can be used as a prediction engine or an explanation engine depending on the initial numerical values of the properties in the data structure. Furthermore, it can comprise an inference engine, a user interface, and an explanatory interface. The components can be embedded in the system or be distributed among several nodes and/or servers.

The system of the invention thus either predicts or explains results of running of the data model. The data model is a software product in an embedded module having access to a knowledge base of rules, explicit facts and/or configuration data.

The software product comprises means that are configured to load a computer code into a memory of a computer to be executed in a processor connected to said memory, the computer code being arranged to execute the method of the invention.

Use and Advantages

The rule-based method and system of the invention can be used to manage and/or manipulate or get information of knowledge by interpreting the outcome of the algorithm in a useful way.

The method according to the invention can predict what facts needs to become valid in order to trigger any of the rules in the system to produce a given inferred property based on the system, where facts and rules can be inserted and deleted in runtime.

The embodied method does not require any learning phase for educating the data model and not even pre-existing sample data tuples. The embodied method can be applied to a new environment by maintaining the same data structure but starting with empty data to predict rule results right from the start and the method can be applied in real-time environments where the data tuples of rules change.

In prior art, it is computationally difficult to identify a sequence of rules that can lead to a satisficing solution. In traditional prediction methods, where a neural network or other statistical analysis is being used, changes of the ruleset require a learning phase to be re-run. The method of the invention does not need any learning phase at all. The embodied method can adapt rule changes immediately without the need of reconstruction of the data model.

The invention is useful for services in application areas that benefit of quick reaction of events based on complex rules, such as failure monitoring systems, because it provides means to react on events before they actually trigger.

Another application area for the embodied method is to find closest matches based on rules. For example, properties of an unemployed person can be used as a rule to find closest matches from open job positions.

In addition, the method provides recommendations as concrete facts for the person in order to qualify for job positions, for example a software engineer may receive a recommendation to take a specific programming language course in order to qualify for an open programming job position.

According to an embodiment of the invention, a news server is implemented within the system.

The invention is primarily intended for Description logics (DL) that consists of formal knowledge representation languages. Description logic (DL) models concepts, roles and individuals, and their relationships. The embodiments of the invention are, however, free from certain restrictions and is thus not e.g. restricted to a particular language, so it supports also other formal semantics than description logic (DL).

It is an advantage that the method embodied by the invention does not need decision trees to operate.

Matrix operations are greatly suitable for fast graphics processing unit (GPU) processing as well to reduce the payload from a Central Processing Unit (CPU) and provide fast evaluation of complex rule sets with thousands of rules or knowledge bases with thousands of properties.

In the following, the invention is described by means of some example embodiments by referring to figures and mathematical examples. The invention is not restricted to the details of these examples.

### FIGURES

FIG. 1 is an architecture view of the system of the invention.

FIG. 2 is a general flow scheme of the method of the invention.

### DETAILED DESCRIPTION

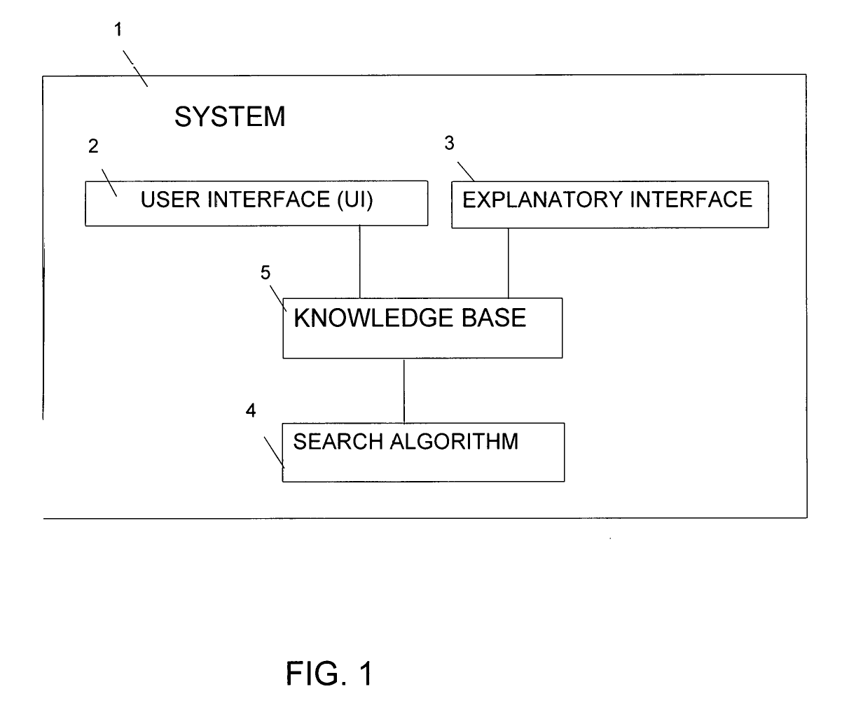

FIG. 1 is an architecture view of a schematic block diagram of software module components of a system 1 of the invention. The system is an embedded system and can be programmed to employ a data model using an algorithm 4 applied on a knowledge base 5 for working as a prediction engine or an explanation engine. The components can be embedded in the system 1 in one data network node or be distributed among several nodes and/or servers. The algorithm 4 has access to the knowledge base 5.

Furthermore, it comprises a user interface 2 and an explanatory interface 3. The user interface 2 can be connected to the explanatory user interface 3.

The system 1 is implemented in a computer with a processor and a memory and the method of the invention is computer-implemented.

The knowledge base in a data base module 5 is a data structure that comprises a set of properties as explicit facts and a set of rules that represent relations of the properties. The data model uses the data structure of explicitly given data of facts and/or rules to predict or explain outcome when the rules are applied on the explicit facts. The explicit facts state relevant properties of subjects and the outcome is a result for applying the rules on the explicit facts.

In some embodiments, a sub-ensemble of all facts can be loaded into a working memory used by the system so that work with extensive data is avoided when only that sub-ensemble is worked with.

The algorithm 4 is a software program, which executed by the processor performs instructed steps of the computer-implemented method of the invention in accordance with the data model by applying the rules on the facts from the structured data in the knowledge base and by outcoming a search result.

The algorithm performs a finite sequence of steps for solving a satisfiability problem.

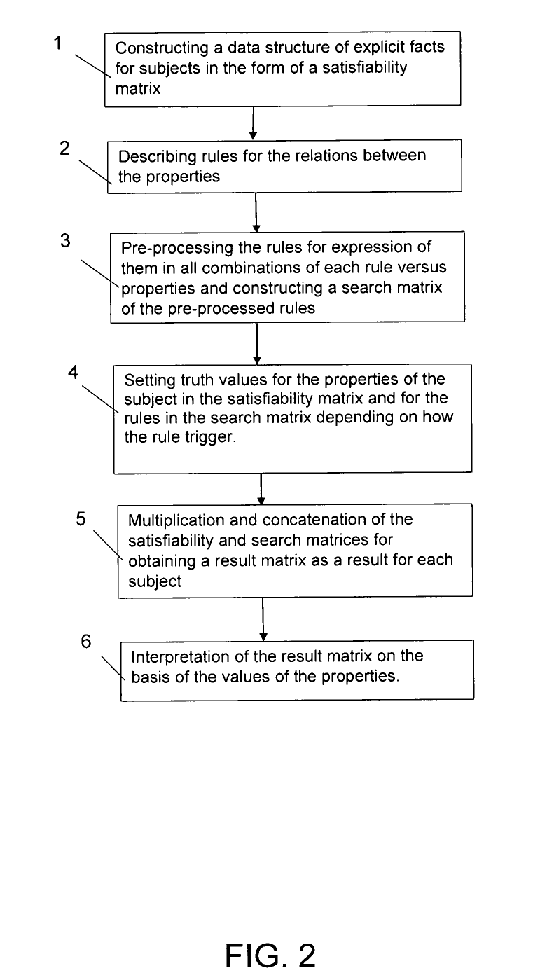

Steps performed by the algorithm is presented in FIG. 2 as a flow chart. The flow chart in FIG. 2 shows the overview of an embodiment of the method of the invention.

The search result can be interpreted depending on how the knowledge-base is pre-calculated for prediction, explanation or even for pure inference. The data model can thus be used as an inference engine, which gives an outcome of inferred facts when the rules are applied on the explicit facts.

Furthermore, the system 1 has a user interface 2 through which a user may enter commands and information into the system 1 such as through a keyboard, pointing device, mouse or other control means.

The user interface (UI) 2 is the space where the interactions between the user and the system 1 occur. The interaction allows operation and control of the system 1 from the human end, whilst the system 1 simultaneously feeds back information as a feedback to the running of the algorithm.

The system 1 also has an explanatory interface 3 for interacting with a user or external devices. The explanatory interface 3 provides communication between the user and the system by justifying the reasoning of the system and makes it possible for the user to ask how the system is reaching conclusions or why it is asking a specific question.

The system 1 is a node in a network. The method according to an embodiment of the invention can execute the method in one node or it is possible to distribute at least one method step into another processing node than the executing node.

The method according to an embodiment of the invention can thus comprise providing said another node with an individual working memory, shared access to a rule set and/or the right to check/evaluate the value of a property for any subject.

FIG. 2 is a flow scheme of the method of the invention, which can be utilized for predicting or explaining results by using a data model with explicitly given data of facts and/or rules.

The method starts in step 1 by constructing a data structure of properties stating explicit facts for subjects. As in this example, the data structure can be in the form of a satisfiability matrix with rows for presenting the subjects and columns for presenting the properties. The satisfiability matrix is stored in a knowledge-base (KB) as a part of that.

Rules defining how the properties are related to each other are then expressed and stored and are also stored in the knowledge-base as a part of that in step 2. The rules can in this stage be grouped together in statements including both “ANDs” and “ORs” and parenthesis (brackets).

The rules are then preprocessed in step 3 by separating them into a sequence of only ORs (=converted into Disjunctive Normal Form (DNF)) and thereafter expanded. The rules are now a disjunction of conjunctive clauses; i.e. a disjunction of one or more conjunctions of one or more literals. Thus, the relations are split so that each rule only has “ANDs” and is true for each property it comprises, and the rules are separated from each other by “ORs”.

A representation of all combinations of the rules is constructed in the form of a search matrix so that each expanded rule has an own (horizontal) row in the matrix and each property has a (vertical) column. The expanded rules are thus presented by rows and the columns by the properties. The satisfiability matrix and the search matrix will be of equal size.

In step 4, truth values are then set for all the properties of the subject by inserting “zero” or “one” for the properties in the satisfiability matrix and by inserting “zero” or “one” for the rules in the search matrix depending on how the rule trigger. The values “zero” and “one” (“0” and “1”) are chosen in the satisfiability matrix to express “true or “false” depending on if the data model is going to be used for prediction or explanation.

In step 5, the values in corresponding cells of the satisfiability matrix and the search matrix are then multiplied (one by one) and result matrices for all subjects are obtained so that each subject has separate result matrices for each expanded rule. A concatenation of the matrices is also performed in so that a concatenated result matrix is obtained for each subject comprising all the expanded rules.

Interpretation of the result matrix is performed on the basis of the basis of the values of the properties is then performed, which is indicated with step 6 in FIG. 2.

Interpretation and use of the resulting matrices of the respective subjects can be done with respect to different aspects.

Interpretation
a) We can predict if a property of interest can be true for subjects when in the satisfiability matrix, “0” represents true and “1” represents false.

The non-zero values in the result matrix for a subject indicates the required facts to make a rule to match for a subject.

If there are no non-zero values in the matrix for the subject for a given expanded rule, then the property of interest can not satisfy the property with the given expanded rule.

The non-zero values of the properties in a result matrix for a subject shows which properties are satisfied by that subject and the zero values shows missing facts for that subject.

If there are no non-zero values in any of the matrices for a subject then the subject cannot satisfy the property of interest at all.
b) We can get an explanation of which facts produced an inferred property for subjects when in the satisfiability matrix, “1” represents true and “0” represents false.

A rule satisfy a property for a subject if there is the same amount of matching properties in the search matrix and the satisfiability matrix.

The non-zero values of the properties in a result matrix for a subject indicate the facts that produced (i.e. inferred) a property and made the required rule to trigger (i.e. or to match).

### Example Embodiment of the Invention

Introduction

The program logic used in the invention is expressed in terms of relations, and a computation is initiated by running a query over these relations.

The relations are defined by clauses, which are expressions formed from literals in the form of facts and rules.

Relationships are stated by using logical connectives. The logical connective “or” is the truth-functional operator of (inclusive) disjunction, also known as alternation; The logical connective “and” is a conjunction.

Generally five connectives are used, which are OR (∨), AND (∧), Negation/NOT (¬),

Implication/if-then (→), If and only if (⇔).

Execution is initiated by the user's posting of a single goal, called the query. Queries can be made by conjunction of goals and disjunction of goals.

Rules define relationships between properties. The system can then be used by asking questions above relationships between the properties.

Rule expansion specifies the separate sets of words or phrases within a rule that are used to match user input. Rule expansions also specify the required sequence of the phrases that are used for input.

The conjunction of a family of properties is defined as the property of an object satisfying all the given properties. The disjunction of a family of properties is defined as the property of an object satisfying at least one of the given properties. The negation of a property is the property of not satisfying that property.

A Horn clause is a logical formula of a particular rule-like form which gives it useful properties. A Horn clause is a disjunction with at most one positive, i.e. unnegated, literal. Conversely, a disjunction of literals with at most one negated literal is called a dual-Horn clause.

Horn clauses are also the basis of logic programming, where it is common to write definite clauses in the form of an implication:

(p∧q∧ . . . ∧t)→u

Such a language can also provide various built-in predicates to perform routine activities like input/output, using graphics and otherwise communicating with the operating system.

Satisfiability and validity are elementary concepts of semantics. In a satisfiable problem, it is determined if there exists an interpretation or a model that satisfies a given formula. A formula is satisfiable if it is possible to find an interpretation (model) that makes the formula true. A formula is valid if all interpretations make the formula true. The opposites of these concepts are unsatisfiability and invalidity, that is, a formula is unsatisfiable if none of the interpretations make the formula true, and invalid if some such interpretation makes the formula false.

The formula is satisfiable if there is a collection of one or more rules that render the formula true.

We use a data model to predict or explain satisfiability of a satisfiability formula constructed in accordance with the invention after fixing the values of the variables (i.e. properties) in the formula, by inputting the initial values as either true or false) of each variable.

The formula is constructed by using propositional expression consisting of literals, parentheses, and operators which has some semantic content.

The values of the variables are the truth values true and false, usually denoted 1 and 0 respectively. A variable takes one of two values from the set {0, 1}. A variable v may be negated in which case it is denoted ¬v. The value of ¬v is opposite that of v.

Propositional formula is a type of syntactic formula having a truth value. Propositional formulas are constructed from atomic propositions by using logical connectives.

An implication is a statement that applies something by means of an if-then rule like, an implication A→B is the proposition: “if A, then B”. It is false if A is true and B is false. The rest cases are true.

Horn-satisfiability, is the problem of deciding whether a given set of propositional Horn clauses is satisfiable or not.

Searching is here a process of finding by means of an algorithm whether a key element belongs to a search space or not. The algorithm used in the invention is inventive and has several advantages over those used in prior art.

The proposed Matrix Search Algorithm is presented as a matrix that uses an order of m×n and key elements to be searched as input. The search procedure used in the invention finds e.g. out which rule or fact would make a satisfiability formula, such as a satisfiability matrix, satisfiable for a given property. Another embodiment finds out facts that gave an inferred property. A third embodiment finds out for which subject a search result is closest to given properties of interest.

In mathematics, there is, in a matrix, a rectangle of numbers, arranged in rows and columns. The rows are each left-to-right (horizontal) lines, and the columns go top-to-bottom (vertical). A cell is a position at a given row and at a given column.

A matrix formula of m clauses and n variables may be represented as an m×n (0,±1)−matrix M where the rows are indexed on the clauses, the columns are indexed on the variables, and a cell M(i, j) has the value +1 if clause i contains variable j as a positive literal, the value −1 if clause i contains variable j as a negative literal, and the value 0 if clause i does not contain variable j as a positive or negative literal.

In the advantageous embodiment of the invention, the rules considered are of the Horn-clause type.

The solution of the invention can use a data model for finding goal requirements. It is a model with structured knowledge about properties stating explicit facts and the logical connections between them as a presentation of rules.

The knowledge of explicit data is represented by basic properties that cannot be derived or computed from any other knowledge. Since the model also includes rules, there are also properties that can be inferred from other properties.

Explicit data is data that is provided intentionally and taken as a value rather than analyzed or interpreted for further meaning. Explicit data, in turn, is data that is not intentionally provided and may only be derived from analysis of explicit data. A property that is derived from other properties thus represent implicit data.

The modeling starts with term (i.e. property) and fact identification. The term-fact modeling is performed to capture semantics in a way that enables development of the rule-based system of the invention and the model drives the rules.

The knowledge base contains a set of rules and facts and the algorithm applies rules on facts. The algorithm exposes facts that can be predicted as giving certain conclusions before the rules are triggered.

Stating Rules and Explicit Facts

The implementation of the invention uses a rule-based data model that uses a satisfiability matrix and a search matrix as the data structure.

We have properties that state explicit facts for subjects.

Rules describe how the properties are related to each other.

The rules are horn logic clauses (Horn, 1951) that can be expressed as an implication formula:

(p₀∧p₁∧ . . . ∧pₙ)→p′₀

For simplicity reasons, the embodied method allows more than one positive literal in this disjunction because it can be easily seen that such horn clauses, having identical negative elements p but different positive elements p′, can be combined into an implication formula:

(p₀∧p₁∧ . . . ∧pₙ)→(p′₀∧p′₁∧ . . . ∧p′ₘ)

Rule r:

r: (p₀∧p₁∧ . . . ∧pₙ)→p′ᵣ

, where p is
a property (term) that is true or false for a subject (resource) x,
a first-order function f(x) returning true or false.

The rules defining how the properties are related to each other are then expressed and stored in the knowledge-base in the form of a set of rules R and a set of properties p

R: {r₀, . . . , rₘ}

A rule r is considered applicable and satisfies the satisfiability formula if and only if all of its properties are either true or inferred from another applicable rule:

$$∀ i : {p}_{i} = \{ \begin{matrix}true , or \\ ∃ x ∈ \{ 0 , m \} that rule {r}_{x} : ( \begin{matrix}{p}_{0} & & … & & {p}_{n}\end{matrix} ) -> {p}_{i} is applicable\end{matrix} .$$

Constructing a Satisfiability Matrix

A satisfiability matrix of explicit facts presenting the properties of each subject is constructed.

Given the set of properties P¹ (x) . . . P^{m} (x), the satisfiability matrix Mₓ for one subject x is thus:

$${M}_{x} = [ \begin{matrix}{p}_{x}^{1} & {p}_{x}^{2} & … & {p}_{x}^{m}\end{matrix} ] , where$$

$$\begin{matrix}{p}_{x}^{m} = 0 , if {P}^{m} ( x ) is true \\ = 1 , if {P}^{m} ( x ) is false\end{matrix}$$

The complement matrix Mₓ⁻¹ of satisfiability matrix Mₓ is:

Mₓ⁻¹=[(1−p₁¹)(1−p₂²) . . . (1−pₓ^{m})]

wherein the zeros and the ones are interchanged in the complement matrix.

Changes in the data (consisting of the facts, rules, and the properties) change the satisfiability matrix.

Modifying the Satisfiability Matrix for New Subjects, Facts and Properties

The satisfiability matrix can be modified by deleting facts and properties from or inserting facts and properties in the satisfiability matrix.

For every new subject to be considered, a new empty row is added to the satisfiability matrix. The ordering of the subject rows is not relevant. Empty rows (rows without non-zero values) can be removed from the matrix either real-time or in batches because empty rows will not affect the results.

New properties are added to the satisfiability matrix as new empty columns. Empty columns (columns without non-zero values) that are not referenced from rules can be removed from the matrix either real-time or in batches because they do not affect the results.

Insertion of a Fact Contains at Least One of the Following Operations:
1. assertion that the property stating the fact does not already hold for the given subject,
2. if the subject for which the fact is to be inserted is not in the system yet, a new row full of 1s is added to the satisfiability matrix, when the method is used for predicting.
   When it is used for explanation, a new row full of 0s is added to the satisfiability matrix.
3. if the property for which the fact is to be inserted is not in the system yet, a new column full of 0s is added to the search matrix and a new column full of 1s is added to the satisfiability matrix, when the method is used for predicting or a new row full of 0s is added to the satisfiability matrix, when the method is used for explanation,
4. selecting such a cell from the satisfiability matrix that corresponds to a row based on the order of the subject and that corresponds to a column based on the order of the property and changing the cell value to 0 when the method is used for predicting or changing the cell value to 1, when the method is used for explanation.

Deletion of a Fact Contains at Least One of the Following Operations:
1. assertion that the property the fact of which is deleted holds for the given subject,
2. selecting such a cell that corresponds to a row from the satisfiability matrix that corresponds to a row based on the order of the subject'and that corresponds to a based on the order of the property and changing the cell value to 1, when the method is used for predicting or changing the cell value to 0, when the method is used for explanation.

Insertion of a Rule Contains at Least One of the Following Operations:
1. assertion that the rule does not already exist,
2. pre-processing the rule into a set of expanded rules,
3. adding a new row to the search matrix for each expanded rule, in a way that for each property in the body of the rule corresponding cell in the row is set to 1 and for non-existing property in the body of the rule corresponding cell in the row is set to 0.

Deletion of a Rule Contains at Least One of the Following Operations:
1. assertion that the rule exists,
2. pre-processing the rule into a set of expanded rules,
3. removing all rows from the search matrix corresponding to the expanded rules, which were added during insertion of a rule in step 3 above.

Constructing a Search Matrix

A search matrix for matching rules to the satisfiability matrix in a searching operation is then constructed.

So that such a matrix could be constructed the rules are pre-processed.

For that purpose, a rule r is converted into disjunctive normal form (DNF) and split by ORs into separate rules rₓ′ . . . , r_{x″}ⁿ. A disjunctive normal form (DNF) is a standardization (or normalization) of a logical formula which is a disjunction of conjunctive clauses.

Given a set of rules R in the system, the rules are expanded into all combinations where pₙ=p′ᵣ by substituting pₙ with premises of rule r:

Formally, given rules rᵢ and rⱼ:

rᵢ: p¹ⁱ . . . p^{ai} . . . p^{mi}→p′ᵢ

rⱼ: p^{1j} . . . p^{mj}→p′ⱼ

If p′ⱼ=p^{ai} then an expanded rule rᵢ′ can be added to the system:

rᵢ′: p¹ⁱ . . . (p^{1j} . . . p^{mj}) . . . p^{mi}→p′ᵢ

Prediction

To predict how a given property of interest p′ᵣ(x) can become true, a search matrix is constructed from properties p¹ . . . p^{m} (and expanded rules r₁ . . . rₙ):

$$S = [ \begin{matrix}{p}_{r 1}^{1} & … & {p}_{r 1}^{m} \\ ⋮ & ⋱ & ⋮ \\ {p}_{r n}^{1} & … & {p}_{r n}^{m}\end{matrix} ] , where$$

$$\begin{matrix}{p}_{n}^{m} = 1 , if rule {r}_{n} has {p}_{m} premise , \\ = 0 , otherwise .\end{matrix}$$

and a search is performed so that a vertical concatenation of the satisfiability matrix and the search matrix is made after having multiplied them. The matrix multiplication and concatenation is an operation that produces a matrix from two matrices.

The result is obtained by a vertical concatenation of the following matrices:

Hᵢⱼ=Sᵢ∘Mⱼ(Hadamard product)

, where
Sᵢ=ith row of the search matrix, and
Mⱼ=satisfiability matrix of subject xⱼ.

The result matrices can be interpreted by the non-zero values indicating the required facts to make a rule to match for a subject. If there are no non-zero values in the result matrix, then the subject cannot satisfy the property p′ of interest with the given expanded rule. If there are no non-zero values in any of the matrices for the subject, the subject cannot satisfy the property p′ at all with any rule.

Explanation

To figure out which fact(s) produce(s) a given property p′ of interest for a given subject x, in other words how p′(x) can be true, a search matrix can be used to calculate the facts and rules that produce p′.

Rule rᵢ satisfies p′(xⱼ) if there is the same amount of matching properties in the search matrix Sⱼ and the satisfiability matrix Mⱼ:

rᵢ satisfies p′(xⱼ)⇔ΣSᵢ=Σ(Sᵢ∘Mⱼ⁻¹)

and a search is performed so that a vertical concatenation of the satisfiability matrix and the search matrix is made after having multiplied them. The matrix multiplication and concatenation is an operation that produces a matrix from two matrices.

The result is a vertical concatenation the following matrices:

Eᵢⱼ=Sᵢ∘Mⱼ⁻¹(Hadamard product)

, where
Sᵢ=ith row of the search matrix, and
   Mⱼ⁻¹=complement matrix of Mⱼ of subject xᵢ and
   rᵢ satisfies p′(xⱼ).

The result matrices can be interpreted by the non-zero values indicating the explicit facts that make a rule of interest to match for the subject.

The results can be ordered or filtered based on how close the subject is to match a given solution with respect to properties of interest. The ordering value Σᵢⱼ for solution Hᵢⱼ can be calculated as:

Σᵢⱼ=ΣHᵢⱼ=Σ(Sᵢ∘Mⱼ)

If Σᵢⱼ=0, the subject xⱼ cannot match for expanded rule rᵢ.

If Σᵢⱼ is a small number, the subject xⱼ is close to match with expanded rule rᵢ.

If Σᵢⱼ is a large number, the subject xⱼ is not likely to match with expanded rule rᵢ.

### CALCULATION EXAMPLE

Let us consider a rule set R:

r₁: p1∧(p2∨p3)→p4

r₂: p4∧p5→p6

and subjects x₁, x₂ and x₃ that currently has the following properties true:

x₁: p1, p3 and p4,

x₂: p1,

x₃: p3, p4, p5 and p6.

The satisfiability matrix M for subjects x1, x2 and x3 is:

$$M = [ \begin{matrix}0 & 1 & 0 & 0 & 1 & 1 \\ 0 & 1 & 1 & 1 & 1 & 1 \\ 1 & 1 & 0 & 0 & 0 & 0\end{matrix} ]$$

The expanded forms of rules r1 and r2 are:

r₁′: p1∧p2→p4

r₁″: p1∧p3→p4

r₂′: p4∧p5→p6

r₂″: p1∧p2∧p5→p6

r₂″′: p1∧p3∧p5→p6

To predict p6 the following search matrix S can be constructed for expanded forms of rules that can produce p6:

$${S}_{p 6} = [ \begin{matrix}0 & 0 & 0 & 1 & 1 & 0 \\ 1 & 1 & 0 & 0 & 1 & 0 \\ 1 & 0 & 1 & 0 & 1 & 0\end{matrix} ]$$

The result matrices for x1 . . . x3 are concatenation of Sᵢ∘Mⱼ matrices:

$$\begin{matrix}{H}_{x 1} = [ \begin{matrix}0 & 0 & 0 & 0 & 1 & 0 \\ 0 & 1 & 0 & 0 & 1 & 0 \\ 0 & 0 & 0 & 0 & 1 & 0\end{matrix} ] \\ {H}_{x 2} = [ \begin{matrix}0 & 0 & 0 & 1 & 1 & 0 \\ 0 & 1 & 0 & 0 & 1 & 0 \\ 0 & 0 & 1 & 0 & 1 & 0\end{matrix} ] \\ {H}_{x 3} = [ \begin{matrix}0 & 0 & 0 & 0 & 0 & 0 \\ 1 & 1 & 0 & 0 & 0 & 0 \\ 1 & 0 & 0 & 0 & 0 & 0\end{matrix} ]\end{matrix} \text{=>} {H}_{x} = [ \begin{matrix}0 & 0 & 0 & 0 & 1 & 0 \\ 0 & 1 & 0 & 0 & 1 & 0 \\ 0 & 0 & 0 & 0 & 1 & 0 \\ 0 & 0 & 0 & 1 & 1 & 0 \\ 0 & 1 & 0 & 0 & 1 & 0 \\ 0 & 0 & 1 & 0 & 1 & 0 \\ 0 & 0 & 0 & 0 & 0 & 0 \\ 1 & 1 & 0 & 0 & 0 & 0 \\ 1 & 0 & 0 & 0 & 0 & 0\end{matrix} ]$$

The result matrix H can be interpreted as the following (row by row):
“x1 will have P6 if P5” (Σ=1)
“x1 will have P6 if P2 and P5” (Σ=2)
“x1 will have P6 if P5” (Σ=1)
“x2 will have P6 if P4 and P5” (Σ=2)
“x2 will have P6 if P1 and P5” (Σ=2)
“x2 will have P6 if P3 and P5” (Σ=2)
   “x3 cannot have P6” (Σ=0)
“x3 will have P6 if P1 and P2” (Σ=2)
“x3 will have P6 if P1” (Σ=1)

An explanation matrix can be used for interpreting why a property is true for given subject. In the example above property p6 is true for subject x3. The explanation matrix Eₓ₃ is:

$${E}_{x 3} = {S}_{p 6} ∘ {M}_{x 3}^{- 1} = [ \begin{matrix}0 & 0 & 0 & 1 & 1 & 0 \\ 0 & 0 & 0 & 0 & 1 & 0 \\ 0 & 0 & 1 & 0 & 1 & 0\end{matrix} ]$$

Third row is the only row that satisfies p6, e.g. ΣS_{i l =Σ(S}ₚ₆∘Mᵢ⁻¹)) that can be interpreted as: “x3 has p6 because it has p4 and p5”.

1. A computer-implemented reasoning method for analyzing inference by using a data model with facts and rules, the data model being used for analyzing rule triggering by means of an algorithm, the method comprising:
providing the data model as a data structure with
a presentation of property values for subjects, whereby each property value states an explicit fact or a missing fact, and
a presentation of rules for the relations of the properties, the rules having been constructed in an expanded form showing separately all combinations of property relations,
the algorithm combining the presentations of the data structure by matching the rules against the properties of the subjects,
obtaining a search result exposing the relations between the rule results and the property values of the subjects, and
interpreting the search result on the basis of the property values.

2. The method of claim 1, wherein the explicit facts and missing facts have been given numerical truth values enabling interpreting the search result for predicting reasoning results of inferred facts/produced properties.

3. The method of claim 2, wherein one or more missing explicit fact is interpreted as an additional fact(s), which, when inserted in the data structure, triggers one or more rules thereof.

4. The method of claim 1, wherein the search result is interpreted to predict required facts that produces a given property/infers a fact for one or more subjects.

5. The method of claim 4, wherein a required explicit fact to make a given rule to match for a subject is indicated by a property value stating the property to be true, and a missing fact is indicated by a property value stating the property to be false.

6. The method of claim 2, wherein the subjects and rules that are closest to trigger is found by means of the missing explicit facts making a given rule to trigger, whereby closeness is measured by at least one of:
the amount of missing explicit facts, and
the weights of the missing explicit facts or their corresponding properties.

7. The method of claim 6, wherein the method further comprises sorting rules and subjects based on how close the rules are to match.

8. The method of claim 1, wherein the explicit facts and missing facts have been given numerical truth values enabling interpreting the search result for explaining reasoning results of inferred facts/produced properties.

9. The method of claim 8, wherein the search result is interpreted to determine if a given property for one or more subjects is true and can thus be inferred from explicit facts and satisfy the satisfiability formula.

10. The method of claim 8, wherein the search result is interpreted to find the explicit fact(s) that produced a given inferred property for one or more subjects.

11. The method of claim 8, wherein whereby the facts that made the rule to match for a subject is indicated by the values of the required properties for that rule.

12. The method of claim 1, wherein the data model is provided by constructing a satisfiability formula for the presentations of the properties in the form of a satisfiability matrix with rows for presenting the subjects and columns for presenting the properties,
constructing a search formula for the presentation of the rules in the form of a search matrix from properties and expanded forms of the rules, the expanded rules being presented by rows and the columns by the properties,
obtaining the search result as a resulting data structure in the form of a result matrix by multiplying the satisfiability matrix and the search matrix.

13. The method of claim 12, wherein the multiplication of the satisfiability matrix and the search matrix is followed by concatenation.

14. The method of claim 12, wherein:
the explicit facts and missing facts are given numerical truth values in the satisfiability matrix for enabling interpreting the search result for predicting reasoning results of inferred facts/produced properties, and
interchanging the given numerical truth values of explicit facts and missing facts for enabling interpreting the search result for explaining reasoning results of inferred facts/produced properties.

15. The method of claim 12, wherein the method further comprises interpreting the state of any property for each subject based on the existence of explicit facts indicated by the property values of the cells of the result matrix.

16. The method of claim 12, further comprising interpreting the result matrix by means of values that indicate the required facts that make the rule that infers a property of interest to match for a subject.

17. The method of claims 1, wherein the method further comprises updating the data structure by insertion or deletion of new subjects, rules, and/or facts, whereafter the data model is re-run.

18. The method of claim 1, wherein the method is performed in a network of one or more nodes and further comprising distributing at least one method step into another processing node than the executing node.

19. The method of claim 18, wherein the method further comprises providing said another node with an individual working memory, shared access to a rule set and/or the right to check/evaluate the value of a property for any subject.

20. A non-transitory computer-readable data storage media comprising computer instructions which when executed by a processor cause the processor to perform the method of claim 1.

21. A system for reasoning comprising:
a data base module with a data structure of rules, facts and/or configuration data, the data structure comprising a set of properties stating explicit facts and a set of rules that represent relations of the properties,
a user interface,
a module with an algorithm applying the rules to the data structure by combining the presentations of the data structure by matching the rules against the facts of the subjects and obtaining a search result that exposes the relations between the rule results and the property values of the subjects,

22. The system of claim 21, further comprising an explanatory interface.
